(19) United States
(12) Patent Application Publication
(10) Pub. No.: US 2002/0071388 A1
(43) Pub. Date: Jun. 13, 2002

(54) Selectable network protocol

(76) Inventors: Einar Bergsson, Reykjavik (IS); Brjann Gudjonsson, Reykjavik (IS)

Correspondence Address: KAPLAN & GILMAN , L.L.P., 900NROUTE 9 NORTH, WOODBRIDGE, NJ, 07095, US

(21) Appl. No.: 09/982,109

(22) Filed: Oct. 17, 2001

Related U.S. Application Data
(63) Continuation-in-part of application No. 09/714,348, filed on Nov. 16, 2000.

(51) Int. Cl. H04J 3/14; H04L 12/26

(52) U.S. Cl. 370/230; 370/235

(57) ABSTRACT

A method and apparatus for updating a congestion window in a packet switched network is disclosed. A transmitting terminal first determines whether a receiving terminal is capable of computing packet throughput rates and then selects whether to operate at a constant or a variable transmission rate. If a variable transmission rate, the receiving terminal computes the effective rate and transmits that rate information to the transmitting terminal. The system then adjusts the throughput rate and simultaneously adjusts the congestion window according to the fed back information. If the receiving terminal is not able to calculate a throughput rate, the sending terminal performs such a calculation based upon messages that acknowledge receipt of the transmitted packets.

### RELATED APPLICATIONS

This application is a continuation-in-part of pending patent application Ser. No. 09/714,348, filed Nov. 16,2000, entitled “Network Protocol.”

### TECHNICAL FIELD

This invention relates to a data communications protocol, and more specifically, to a protocol that is optimized for use in wireless data networks.

### BACKGROUND OF THE INVENTION

The use of wireless data network devices is rapidly increasing. Such devices usually comprise a small handheld computer like device that permits a user access to a data network such as the Internet. To date, these devices use communications protocols that are virtually identical to those used in the hardwired, non-wireless devices, such as personal computers and servers.

One problem with utilizing the standard protocols for non-wireless devices for the connection of wireless devices to the Internet is the fact that the protocols make certain assumptions, and take corrective action based upon those assumptions, which are rendered invalid in the wireless environment. The reason for this is that assumptions made about the network are simply wrong when that network is implemented at least partially as a wireless connection.

One example of the above concerns the manner in which network congestion is detected, and the mechanism for correction of such congestion. More specifically, the basic communication protocols utilized for Internet Connectivity are Transport Control Protocol (TCP) and Internet Protocol (IP). These protocols are typically used together, and thus, those of ordinary skill in this art refer to the TCP/IP protocol. The TCP/IP protocol is a standard documented in the following Internet Engineering Task Force (IETF) Request for comments (RFC): RFC-793 1981-09, RFC-1072 1988-10, RFC-1693 1994-11, RFC-1146 1990-3, RFC 1323 1992-5.

As an example of a transmitting terminal 101 and a receiving terminal 102 is shown in FIG. 1 and a wireless terminal 104 is also indicated. A conceptual representation of the Internet is shown as 103.

The TCP frame is embedded within the IP packet. The TCP/IP protocol handles congestion using what is known as a leaky bucket algorithm. In the leaky bucket algorithm, it is recognized that each of the routers through the network may receive packets when the buffer is full. This situation occurs when the transmitting terminal is sending packets at a rate higher than those packets can be routed through the network.

The leaky bucket algorithm simply configures the routers to discard all IP packets that arrive when the routing buffer is full. Thus, discarded packets never reach the destination. Since all packets reaching the destination are acknowledged, the sending terminal is not receiving acknowledgment for packets that have been discarded. The transmitting terminal will then recognize that a packet has been lost, assume the leaky bucket algorithm has discarded the packet, and will retransmit the packet.

Since there is finite time between the transmission of a packet from a sending terminal, and a receipt of an acknowledgement corresponding to that packet at that sending terminal, the question arises as to what rate packets should be sent from the sending terminal during the time that such terminal is waiting for an acknowledgement. Second, the sending terminal must be programmed regarding how long to wait for such acknowledgment before presuming that the packet has been lost.

We turn now to several definitions. The current state of the art utilizes a “congestion window”, defined as the amount of unacknowledged data, in bytes, which has been sent by the transmitting terminal 101 but for which no acknowledgement has yet been received. Put another way, the congestion window is the amount of unacknowledged data in the communication system. The prior art also utilizes a “Maximum Segment Size”, (“MSS”) defined as a fixed number of bytes permitted in a TCP payload, the payload being the data within the TCP packet without including headers and other overhead information. The typical value for the MSS would be 536 or 1460 bytes. The congestion window is used by the transmitting terminal to adjust the flow of packets into the network.

In prior art systems, the congestion window is first set equal to one or two MSS. If no errors occur, then the congestion window is doubled each time the acknowledgment for the previously sent packets are received. The system continues until a packet is lost due to the leaky bucket algorithm previously described. At that time, the system resets and again begins with the initial congestion window equal to one MSS. If the congestion window builds up large enough to reach the same size where the leaky bucket algorithm previously caused packets to be lost, yet packets are not lost the second time that the congestion window reaches such a size, then the rate of increase after second time the congestion window reaches that size is slowed. The leaky bucket algorithm is well known and is documented in classic computer network literature such as Andrew S. Tanenbaum's Computer Networks published by Prentice Hall (ISBN 0-13394248-90000). The entire congestion window adjustment procedure is known and documented in the TCP standard.

The final parameter in prior art systems is the amount of time the sending terminal 101 should wait before it concludes that no acknowledgment is coming, and that the data has been lost. This timer is called a retransmission timer. In prior systems, the retransmission timer is usually initialized at three seconds. The timer is subject to an adjustment algorithm that changes the timer based upon network conditions.

Several problems exist with the present state of the art. First, the system assumes that when a packet is lost and never acknowledged, it is due to a leaky bucket algorithm that has discarded the packet because of congestion. Thus, the algorithm slows down the rate of transmission of future packets in order to alleviate the congestion. In a wireless environment however, the packet may simply have been lost due to a burst of electromagnetic interference, or a user moving into an elevator or other area not subject to receipt of electromagnetic communications. Thus, the system will unfortunately slow down the rate of transmission to alleviate congestion problems, even though there are no congestion problems. This is inefficient, and results in wasted bandwidth.

Another problem is that the timer is adjusted based upon a round trip delay time which may vary greatly in the wireless environment. Thus, spurious variations caused by the wireless nature of the data network will result in improper adjustments to the parameters associated with the protocol.

Fundamentally, both of the foregoing problems are examples of more general problems in such prior systems. More specifically, the communications sessions that occur over a packet data network can be thought of as virtual circuits. A general problem is that the effective bandwidth of the virtual circuit between sending terminal 101 and the receiving terminal 102 depends largely upon network conditions, traffic being transmitted through the network by other terminals, and several other factors. In prior systems, this effective bandwidth is estimated by the transmitting terminal, based upon the number of packets the terminal is sending out and the number of acknowledgments the transmitting terminal is receiving after such packets are transmitted.

The basic flaw is that almost any condition within the network that could cause packets to be delayed or lost, or acknowledgements not to be sent, is usually presumed to be congestion, and adjustments are made as described above. In a wireless system, many factors such as Electromagnetic Interference (EMI), additional delays introduced by the wireless nature of the network, etc. could cause false adjustments. This phenomenon results in the network not being utilized to its maximum bandwidth, and other inefficiencies. Thus, wireless terminals such as terminal 104 of FIG. 1 should not be treated in an identical manner to terminals such as 101. Thus, there exists a need in the art for a technique to distinguish between wireless and hardwired terminals connected to the Internet, and to separately optimize the transmission and congestion parameters associated with each.

### SUMMARY OF THE INVENTION

The above and other problems with the prior art are overcome in accordance with the present invention. The invention facilitates packet communications between a transmitting and receiving terminal in a wireless environment while optimizing the performance and overcoming the drawbacks of the prior art. The invention utilizes a formula calculated at the transmitting terminal in order to adjust the transmission rate and congestion window size.

In accordance with one embodiment of the invention, the system first estimates a rate of change of the “throughput” at the receiver. The present throughput and rate of change of the throughput is fed back to the transmitting terminal and used to estimate the length, in bytes, of the round trip “pipe”; that is, how many bytes will be sent at the present throughput rate before the first byte would traverse the network to a receiving terminal and be returned to a transmitting terminal. The transmitting terminal then utilizes the two different estimates to calculate two different estimated congestion windows. The lesser of the two congestion windows then becomes the new congestion window.

By calculating throughput rate and the rate of change of the throughput at the receiving end, and then transmitting the throughput back to the receiver, the receiver has all of the information it needs to determine the size of the congestion window. This avoids the prior art problem of trying to estimate the size of the congestion window from acknowledgements.

In a more general embodiment, the system estimates the throughput and/or rate of change of the throughput at the receiver. The throughput and its rate of change are then fed back periodically to the transmitter, which adjusts the rate at which packets are fed into the system such that the fed back parameters are substantially matched.

In still another embodiment, the frequency at which the throughput information is fed back to the transmitting terminal may vary, or may be periodic. The frequency may increase as the rate of change of throughput increases, so that rapid changes in throughput are tracked appropriately at the transmitting terminal.

In still another embodiment, a transmitting terminal that sends data into the packet network executes separate algorithms for adjusting the number of packets sent to the network. More specifically, the invention herein contemplates a transmitting terminal that adjusts the congestion window based upon a leaky bucket or similar algorithm (for all hardwired terminals) with which the transmitting terminal communicates, but which utilizes a different algorithm (for communications with wireless terminals). Alternatively, the transmitting terminal may have two modes, each of which utilizes a different algorithm to adjust the congestion window. One algorithm may be for wireless terminals, and another for hardwired.

In a further embodiment of the invention, the transmitting terminal is equipped with a program capable of determining whether a particular receiving agent can provide intelligent responses as to the packet throughput rate. If the particular receiving agent is not capable of such calculation, the transmitting agent utilizes messages acknowledging packet receipt to calculate a throughput rate. The calculated throughput rate is applied to establish a transmission rate.

### BRIEF DESCRIPTION OF THE DRAWINGS

FIG. 1 is a schematic representation of a communication system for use in a wireless environment.

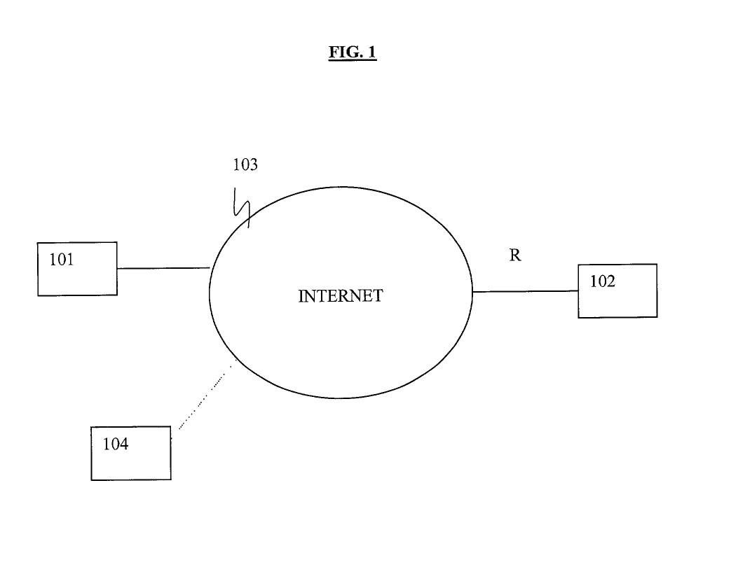

FIG. 2 is a flowchart of a method to calculate a throughput by a receiving terminal.

FIG. 3 is a flowchart for use of an algorithm to calculate a congestion window.

FIG. 4A is a flowchart for distinguishing between receiving terminals as to their ability to calculate a throughput rate.

FIG. 4B is a flowchart of the method by which a non-mTCP agent calculates throughput based on receipt acknowledgement messages.

### DETAILED DESCRIPTION OF THE PREFERRED EMBODIMENT

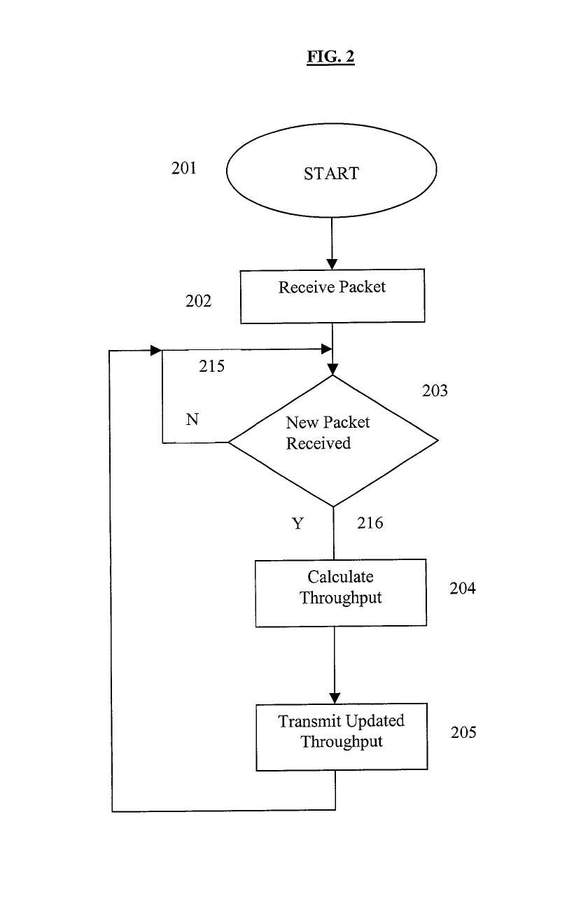

FIG. 2 shows a basic flowchart of the steps executed by a receiving terminal in connection with a communications session occurring over a packet switched data network. It is noted that most communications sessions would be full duplex, and that the arrangement shown in FIG. 2 would be duplicated at both terminals that are parties to the communication session. Additionally, while we show the functional blocks associated with the present invention, it is noted that any receiving terminal may use the techniques of the present invention for operation with wireless connections while using other techniques, such as those in the prior art, for operation with hardwired terminals.

Turning to FIG. 2, the algorithm is entered at start 201 and a packet is received at block 202. Upon receipt of such packet at block 202, the system enters decision point 203 where it continuously loops by means of path 215 until a new packet is received. Concurrently with the looping through path 215, a timer at the receiving terminal keeps a record of how much time is elapsing between the receipt of consecutive packets corresponding to the same communications session. Thus, although the receiver may be receiving plural packets from numerous sources, each of the sources has its own corresponding throughput calculation based upon packets that are from that particular source.

When a new packet is received, the algorithm exits decision point 203 via path 216, and calculates the throughput at block 204. The throughput is easily calculated by knowing the amount of total time it took to receive two packets from the same source.

It is noted that the invention is not limited to performing the calculation each time a new packet is received. Rather, the invention may utilize a smoother function which, for example, receives 10 packets and then calculates the average throughput based upon total time required to receive the 10 packets. Knowing the number of bits in each packet and the time of receipt of each packet, the throughput calculation is straightforward. Additionally, still another method of calculating throughput utilizes a sliding window model. In the sliding window model, several calculations are made and averaged, and the throughput recalculated. Specifically, a burst of N consecutive packets may be transmitted from the sender. The time for receiving those N consecutive packets is calculated at the receiver, and the throughput is ascertained. A second set of N consecutive packets is then utilized to calculate the throughput. Numerous such calculations are made and an average taken. However, the calculations are made using overlapping sets of packets in order to provide a smooth function. Thus, packets 1, 2 and 3 are utilized to calculate throughput 1, packets 2, 3 and 4 may be utilized to calculate throughput 2, and packets 4, 5 and 6 may be utilized to calculate still a third throughput. After a specified number of throughputs are calculated, the average throughput is measured and utilized in the formulas described herein.

Note that while several examples of throughput have been described, various other possibilities may be utilized by those of skill in the art.

The throughput is then transmitted out of the receiver back to the transmitting terminal 101. In a preferred embodiment, the calculated throughput may be transmitted as part of an acknowledgement or other packet already being transmitted with respect to the TCP protocol.

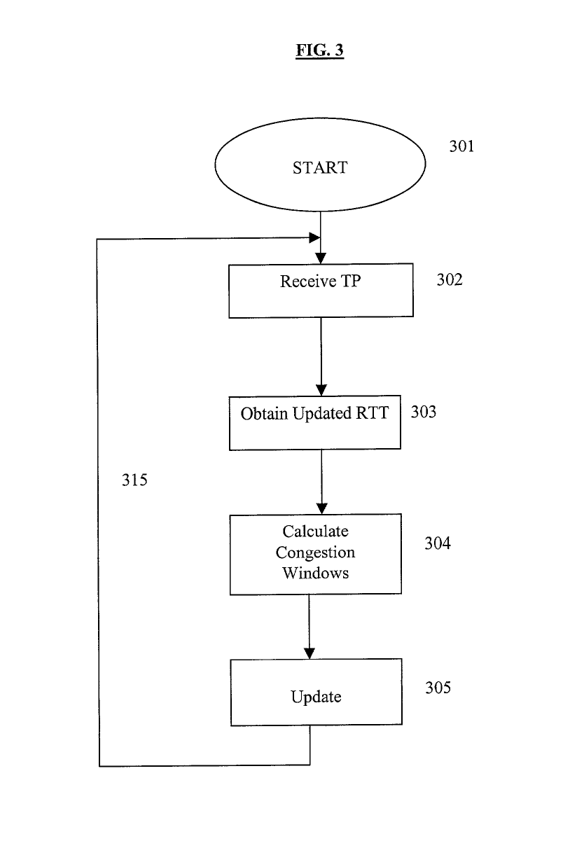

FIG. 3 depicts a functional flow diagram with an algorithm to be implemented at the transmitting terminal in order to facilitate the present invention. The flowchart is entered at start 301 and a packet is received at operational block 302. The updated round trip time is obtained from the memory of the transmitting terminal. This round trip time would typically be maintained in a memory and updated each time an acknowledgment of a packet is received. More specifically, when a packet is transmitted to the network, a timer begins and when the acknowledgement for that packet is received, the roundtrip time is then known.

Block 304 calculates the present congestion window. The congestion window is the number of unacknowledged data in bytes which may be in the communications system. The calculation block 304 attempts to match the congestion window to the throughput and rate of change of throughput measured at the receiver. The specific equations for calculating the new congestion window are set forth below. Nonetheless, the particulars are executed at block 304 and the present congestion window updated at block 305 before returning via path 315 to the top of the flowchart.

In accordance with the present invention, it is recognized that in order to properly adjust the rate at which packets should be sent into the network by the transmitting terminal, it is necessary consider both the actual throughput at the receiving end, as well as changes occurring in that throughput. Thus, if throughput begins slowing down, the fact that such throughput is slowing down will be fed back and/or recognized by the transmitting terminal and will cause a slow down in the input of packets into the network. This is drastically different from prior techniques, where the packets would first overflow and be lost before the transmitting terminal would recognize that too much data has been put into the network.

In accordance with a preferred embodiment of the invention, the following calculations are performed on a dynamic basis. At the receiver, upon receipt of data, a value X is calculated from the throughput. The throughput is calculated as previously described. If the throughput decreases, then X is equal to TP_{N}/TP_{N-1}−1. However, if the throughput is increasing, then the X is calculated as 1−TP_{N-1}/TP_{N}. The variable TPᵢ equals the throughput measurement for the ith measurement, which may be calculated upon receipt of each packet or after every several packets.

Intuitively, X can be thought of as a measure of the rate of change of the throughout. The value X is then utilized to calculate what we term a pipe length. Two pipe lengths are calculated. One of the calculations considers how many bits of information should be on the network and unacknowledged based upon the present throughput and roundtrip time. This pipe length, which we denote P₁ is measured as RTT·TP_{N}. RTT is the round trip time, derived by the difference in time between transmitting a packet and receiving the acknowledgement for that packet. Note that other than the throughput, all calculations are performed at the transmitting terminal.

The second of these pipe lengths accounts for the change in congestion window size caused by the insertion of each packet into the network. This parameter P₂ is measured as CW₋₁+MSS²·X/CW_{N-1}, where CW is the congestion window, and the subscript (N−1) represents the parameter at time (N−1).

Intuitively, P₂ can be seen to vary between a minimum of zero and a maximum of MSS, the segment size of the TCP payload. The fraction is weighted by X which depends upon variations in the throughput measured at the receiving terminal. Accordingly, the parameter P₂ assures that the formula does not erroneously presume that the number of bits and packets that should be transmitted is based upon the most recent measurement of throughput. Rather, the factor X adds a weighting factor which also adjusts the amount of data put into the network based upon changes in the throughput observed at the output (i.e., the receiving terminal).

The system then calculates two potential congestion windows for the next time frame using the following equation: W₁=P₁·|X|+P₂·(1−|X|), W₂=P₂·|X|+P₁·(1−|X|). The lesser of the two windows then becomes the new congestion window. The formula thus takes into account the worst case congestion window based upon both the present state of the system and the present state of rate of change of the system.

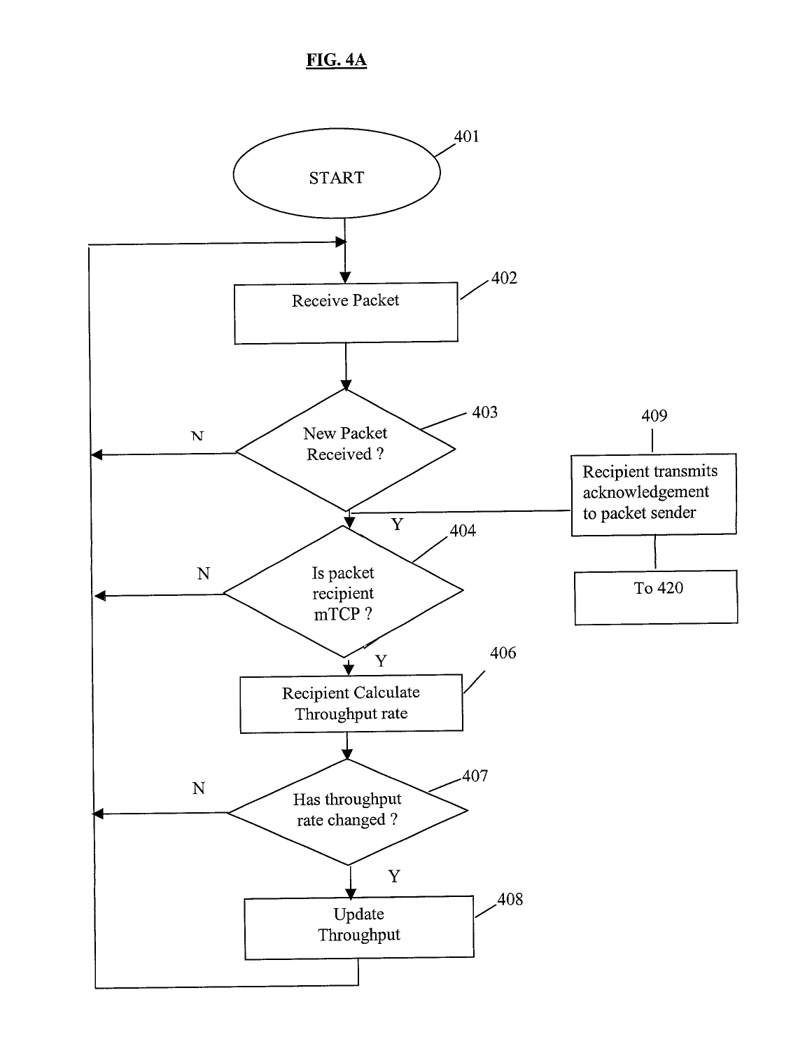

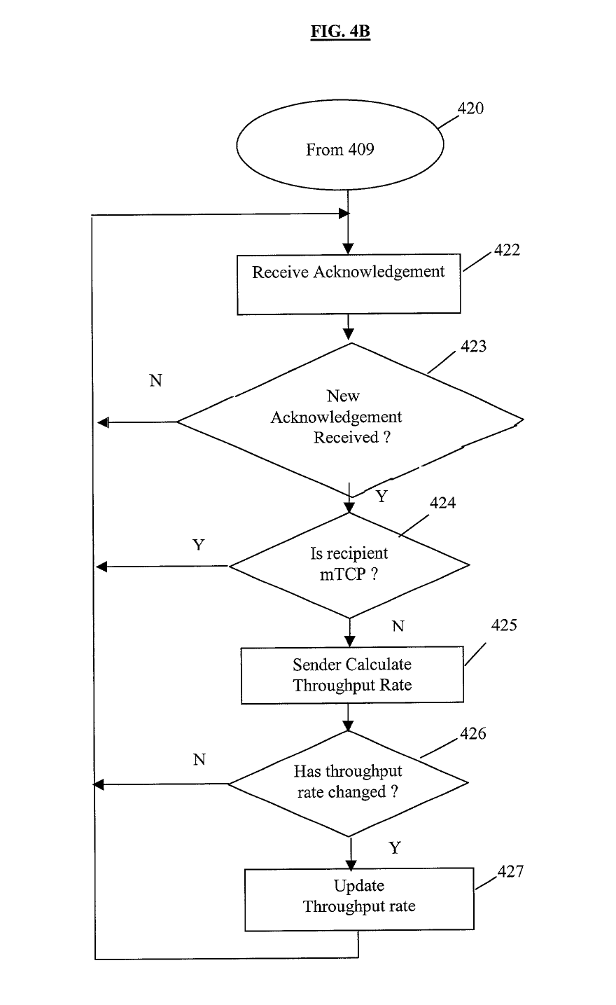

FIG. 4 depicts a functional flow diagram that implements a further embodiment of the present invention in which it is recognized that some terminals are not capable of calculating and providing network intelligence regarding throughput rates. As described above, the sending terminal benefits when a receiving terminal feeds back a signal indicative of the rate at which the network transmits packets so that the rate of transmission can be optimized. However, when a packet is sent to a receiving terminal, the sending terminal my not be aware of whether the recipient has the ability to return an acknowledging signal. Therefore, a further enhancement of the invention provides a process by which the system is able to select between using the method and algorithms described above and a method by which the sending terminal determines that the receiving terminal is not able to calculate throughput rate and thus the sending terminal calculates a throughput rate based upon returned acknowledgement messages.

According to the flow diagram of FIG. 4A, the process is initiated at step 401 and a first packet is received at step 402. The system enters decision point 403 where it is determined whether a packet has been received. If no packet is received, the system recycles to step 402 until a new packet has been received. When a new packet has been received, the recipient transmits an acknowledgement at stop 409 and the process of FIG. 4B is initiated at step 420. A determination is made at step 404 as to whether the recipient agent is mTCP (mobile transport control protocol) programmed and capable of calculating the throughput rate. If the answer to query 404 is positive, the throughput is calculated by the receiver at step 406. If the answer to query 404 is negative, the system reverts to step 402. The system now checks whether the throughput rate has changed from prior rates at step 407. If the rate has not changed, the system goes to step 402. If the rate has changed, the new rate of throughput is installed at step 408 and the system reverts to step 402. The calculated throughput rate is updated at step 408, and the system reverts to step 402 to await an additional packet and continue as described above.

Referring now to FIG. 4B, this portion of the process is initiated from step 409 of FIG. 4A, pursuant to a recipient transmitting an acknowledgement to a sender. The sender of the original message receives an acknowledgement at step 422. Step 423 queries whether a new acknowledgement is received. If not, the system reverts to step 422. If so, a determination of whether the recipient is mTCP capable at step 424. If yes, the system reverts to step 422 because no further action is needed. If not, the sender of the original message calculates a throughput rate at step 425. The system determines at step 426 if the throughput rate has changed. If not, the system reverts to step 422. If so, the throughput rate is updated at step 427 and the system reverts to step 422.

While the above describes the preferred embodiment of the invention, various modifications or additions will be apparent to those of skill in the art. For example, the rate of change of system may be estimated using a variety of formulas for estimating the derivative digitally, and throughput may be measured using various formulas as well. It is possible to change the frequency at which calculations are made, so that in times of rapid change calculations are made more rapidly. For example, the throughput numbers may be updated after predetermined number of packets arrive, however, if the throughput calculation show a change in throughput greater than a predetermined value, then the frequency at which throughput is updated may be increased. Various algorithms for weighting the rate of change and the present throughput may be utilized as well. All of the foregoing are intended to be covered by the following claims.

What is claimed is:

1. A communications system comprising means for determining whether a receiving agent is capable of calculating a throughput rate and means for adjusting a packet transmission rate in response thereto.

2. The communications system as described in claim 1, further comprising means for adjusting the throughput rate in a first manner if the receiving agent is capable of calculating a throughput rate.

3. The communications system as described in claim 1, further comprising means for adjusting the throughput rate in a second manner if the receiving agent is not capable of calculating a throughput rate.

4. The communications system as described in claim 2, further comprising means for adjusting the throughput rate in a second manner if the receiving agent is not capable of calculating a throughput rate.

5. The communications system as described in claim 1, wherein the means for determining whether a receiving agent is capable of calculating a throughput rate comprises a processor at the receiving terminal that is capable of transmitting data to the sending terminal.

6. The communications system as described in claim 4, wherein the means for determining whether a receiving agent is capable of calculating a throughput rate comprises a processor at the receiving terminal that is capable of transmitting data to the sending terminal.

7. A method for optimizing the transmission of packets in a packet communication network comprising determining whether a receiving agent is capable of calculating a throughput rate for such packets, and adjusting the throughput rate in response thereto.

8. The method as claimed in claim 7, further comprising the step of determining if the throughput rate has changed, and if so, updating the throughput rate.

9. The method as claimed in claim 7, further comprising the step of adjusting a throughput rate by a sending agent if the receiving agent is not capable of calculating the throughput rate.

10. The method as claimed in claim 8, further comprising the step of adjusting a throughput rate by a sending agent if the receiving agent is not capable of calculating the throughput rate.
